(19) United States
(12) Patent Application Publication
(10) Pub. No.: US 2016/0093952 A1
(43) Pub. Date: Mar. 31, 2016

(54) COMMUNICATION APPARATUS, CONTROL METHOD, AND STORAGE MEDIUM

(71) Applicant: CANON KABUSHIKI KAISHA, Tokyo (JP)

(72) Inventor: Norihito Aoki, Kawasaki-shi (JP)

(21) Appl. No.: 14/850,512

(22) Filed: Sep. 10, 2015

(30) Foreign Application Priority Data
Sep. 25, 2014 (JP) 2014-195806

(51) Int. Cl. H01Q 3/26

(52) U.S. Cl. CPC H01Q 3/26

(57) ABSTRACT

A communication apparatus having an antenna, for which directivity characteristics can be changed by setting parameters, specifies the parameters of the antenna to obtain directivity characteristics to be used for communication. After specifying the first parameter having a direction of directivity corresponding to the first communication path with another communication apparatus, the communication apparatus searches for the second parameter having a direction of directivity corresponding to the second communication path from parameters obtained by excluding the first parameter from possible parameters. The communication apparatus communicates with the other communication apparatus by setting the antenna using the first and second parameters.

### BACKGROUND OF THE INVENTION

1. Field of the Invention

The present invention relates to a technique of determining antenna directivity characteristics suitable for communication.

2. Description of the Related Art

In recent years, demand for wirelessly transmitting/receiving a large amount of data such as uncompressed moving image data at high speed is growing. To implement such high-speed wireless communication, it is necessary to ensure a wide signal frequency bandwidth, and thus a millimeter-wave communication system which is considered to be able to ensure such wide signal frequency bandwidth is receiving attention. In wireless communication, however, since a millimeter wave largely attenuates due to propagation in addition to a limitation of power, which can be output from a transmitter, by law and the like, a receiver cannot receive a signal without any error in some cases unless the receiver is sufficiently close to the transmitter.

To cope with this, it is possible to increase the distance between the receiver and the transmitter by increasing the reception signal level by the antenna gain of a directional antenna. International Publication No. 2011/055535 describes a technique in which two wireless communication apparatuses in a wireless communication system specify antenna directivity characteristics to be used for transmission and reception.

In the technique described in International Publication No. 2011/055535, however, if there is a shielding object in the direction of directivity of the specified antenna directivity characteristics, a problem that communication is interrupted arises since the straightness of a millimeter electromagnetic wave is especially high. To the contrary, Japanese Patent Laid-Open No. 2010-213190 describes a technique of maintaining communication even when high-speed communication is interrupted, by simultaneously transmitting the same data by low-speed communication in which communication is difficult to be interrupted and high-speed communication in which communication may be interrupted but high-speed data communication is possible. According to Japanese Patent Laid-Open No. 2010-213190, however, if high-speed communication is interrupted, only low-seed communication can be performed, thereby impairing the user convenience.

The present invention has been made in consideration of the above problems, and provides a technique for simultaneously establishing a plurality of high-speed communication paths.

### SUMMARY OF THE INVENTION

According to one aspect of the present invention, there is provided a communication apparatus comprising: an antenna, for which directivity characteristics can be changed by setting parameters; a specifying unit configured to specify the parameters of the antenna to obtain directivity characteristics to be used for communication, wherein the specifying unit searches for and specifies, after specifying a first parameter having a direction of directivity corresponding to a first communication path with another communication apparatus, a second parameter having a direction of directivity corresponding to a second communication path with the other communication apparatus from parameters obtained by excluding the first parameter from possible parameters; and a communication unit configured to communicate with the other communication apparatus by setting the antenna using the first parameter and the second parameter.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 a view showing an example of the configuration of a wireless communication system;

FIG. 2 is a block diagram showing an example of the arrangement of a node;

FIG. 3 is a block diagram showing an example of the arrangement of the wireless interface of the node;

FIG. 4 is a sequence chart showing a processing procedure in a wireless communication system according to the first embodiment;

FIG. 5 is a flowchart illustrating a processing procedure by the SME of a PCP/AP according to the first embodiment;

FIG. 6 is a flowchart illustrating a processing procedure by the MLME of the PCP/AP according to the first embodiment;

FIG. 7 is a flowchart illustrating a processing procedure by the SME of an STA according to the first embodiment;

FIG. 8 is a flowchart illustrating a processing procedure by the MLME of the STA according to the first embodiment;

FIG. 9 is a sequence chart showing a processing procedure in a wireless communication system according to the second embodiment;

FIG. 10 is a flowchart illustrating a processing procedure by the SME of a PCP/AP according to the second embodiment; and

FIG. 11 is a flowchart illustrating a processing procedure by the MLME of the PCP/AP according to the second embodiment.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

Components to be described in the following embodiments are merely examples, and are not intended to limit the technical scope of the present invention. After a description of the configuration of a wireless communication system and the arrangement of a communication apparatus (node) which are common to the respective embodiments, processing procedures different for the respective embodiments will be explained.

(Configuration of Wireless Communication System)

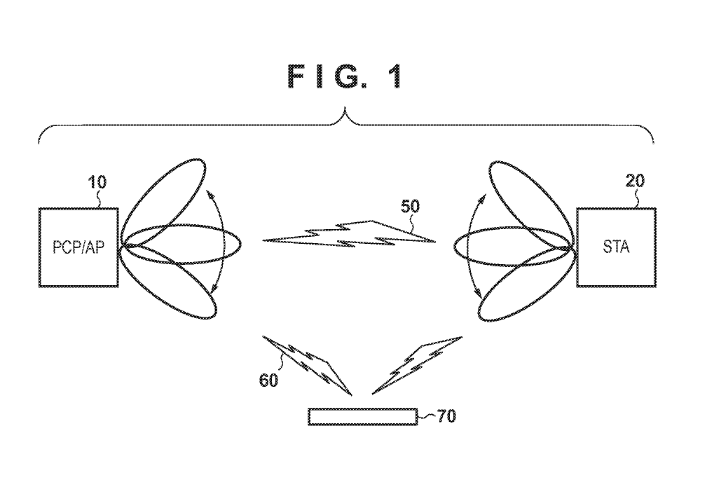

FIG. 1 shows an example of the configuration of a wireless communication system according to each embodiment below. The wireless communication system includes a plurality of communication apparatuses (nodes). In this example, the wireless communication system includes, as nodes, a PCP/AP 10 serving as a master of a network and an STA 20 serving as a terminal. Note that the wireless communication system may further include other nodes. In this example, the PCP indicates a PBSS (Personal Basic Service Set) central point, and the AP indicates an access point. Furthermore, the STA indicates a station (terminal).

Each of the PCP/AP 10 and the STA 20 has a function of adjusting the directivity characteristics (the direction of directivity, the beam width, and the like) of an antenna, and they cooperatively manage the first and second communication paths. The first and second communication paths correspond to, for example, a direct communication path 50 as a communication path on which the line of sight is ensured, and a reflected communication path 60 via a reflective object 70, respectively. Note that when the direct communication path 50 cannot be ensured (the PCP/AP 10 and STA 20 exist in the non-line-of-sight of one another), the first and second communication paths can be reflected communication paths.

(Arrangement of Node)

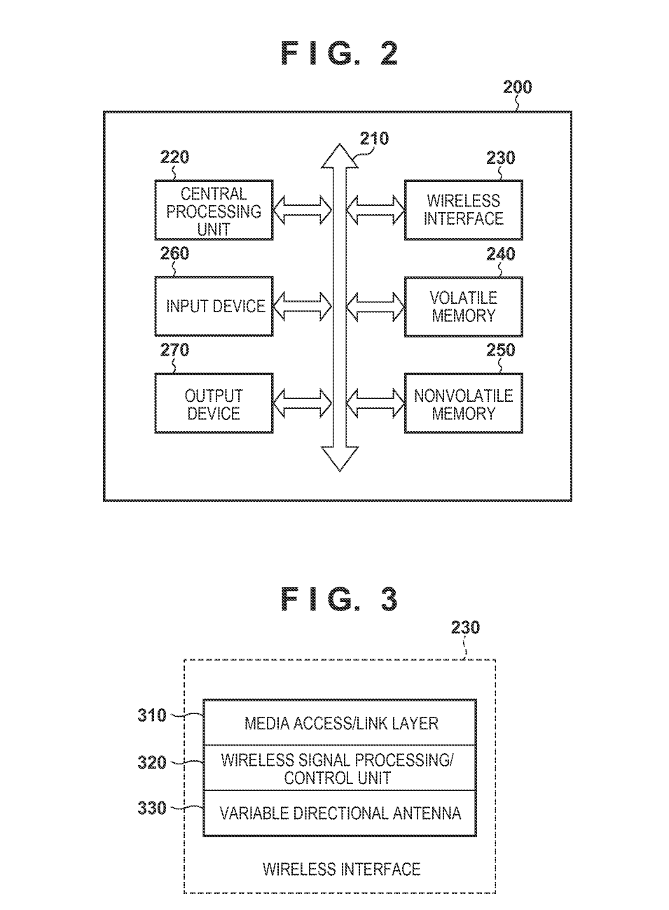

FIG. 2 shows an example of the arrangement of a node 200 (the PCP/AP 10 and STA 20). The node 200 includes, for example, a central processing unit 220, a wireless interface 230, a volatile memory 240, and a nonvolatile memory 250. Note that these function units are interconnected via an internal data bus/control interface 210.

The central processing unit 220 manages the overall operation of the node 200 by reading out information necessary for the operation of the node 200 from programs stored in the nonvolatile memory 250. The central processing unit 220 also generates a control signal to control the wireless interface 230, and communicates the control signal to the wireless interface 230. In addition, the central processing unit 220 executes a beam forming protocol to control the directivity characteristics of the antenna, thereby managing the network and its frequency channels.

The wireless interface 230 is an interface for performing wireless communication with another node. For example, the PCP/AP 10 and STA 20 perform wireless communication using the respective wireless interface 230. Note that a more detailed arrangement of the wireless interface 230 will be described later.

The volatile memory 240 stores temporary data. The volatile memory 240 holds, for example, information such as the directivity characteristics (the direction of directivity and the like) of the antenna obtained as a result of the beam forming protocol executed by the central processing unit 220. The nonvolatile memory 250 holds the programs to be executed by the central processing unit 220, as described above. Note that some of the programs may be stored in the volatile memory 240.

The node 200 may further include one or both of an input device 260 for processing data input from a camera and the like and an output device 270 for outputting display and print data and the like. The input device 260 can be used to accept data such as a still image, moving image, sound, vibration, visible light, infrared light, and text, and input it to the node 200. The output device 270 can be used to output data such as a still image, moving image, sound, vibration, and text outside the node 200. For example, if the node 200 is a data source, data obtained from the input device 260 is transmitted onto a wireless medium via the wireless interface 230. On the other hand, if the node 200 is a data sink, data is received via a wireless medium using the wireless interface 230, and the output device 270 outputs the received data in some cases.

FIG. 3 shows an example of the arrangement of the wireless interface 230. The wireless interface 230 includes, for example, a media access/link layer 310, a wireless signal processing/control unit 320, and a variable directional antenna 330.

The media access/link layer 310 converts data input/output to/from the wireless interface 230 into a packet on a wireless medium, controls the wireless medium, adds an error detection code to the packet at the time of transmission, and detects an error included in the packet at the time of reception. The media access/link layer 310 assigns the same packet number when transmitting the same data as a packet a plurality of times. Upon receiving a packet of the same packet number, the media access/link layer 310 selects a packet in accordance with an error detection result or combines a plurality of received packets, thereby generating one data.

The wireless signal processing/control unit 320 performs, for example, encoding/decoding of data based on a predetermined error correction code, conversion between a digital signal and an analog signal, that is, A/D conversion or D/A conversion, and conversion between a baseband signal and a radio frequency (RF) band. The variable directional antenna 330 is an adaptive array antenna including a plurality of antennas, and can control directivity characteristics such as the direction of directivity by controlling the phase and amplitude of a signal input to each antenna. A lens antenna may be used as the variable directional antenna 330 in place of the adaptive array antenna.

Some embodiments of a wireless communication system having the above-described arrangement and processing executed by nodes of the wireless communication system will be described.

### First Embodiment

(Processing Procedure in Wireless Communication System)

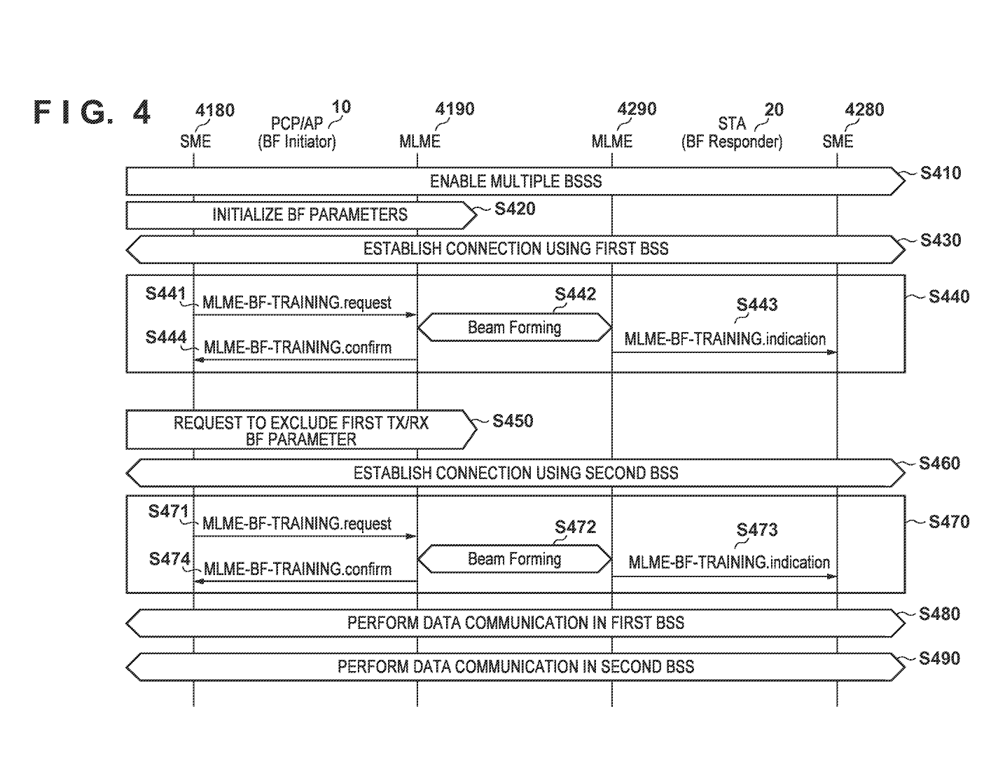

In this embodiment, a case will be described in which a beam forming protocol executed between a PCP/AP 10 and an STA 20 is activated to establish a communication path based on the IEEE802.11ad standard. FIG. 4 is a sequence chart showing a processing procedure executed in a wireless communication system according to this embodiment. Note that the PCP/AP 10 includes an SME (Service Management Entity) 4180 and an MLME (MAC Layer Management Entity) 4190. Similarly, the STA 20 includes an SME 4280 and an MLME 4290. The SME and MLME are implemented across, for example, a central processing unit 220 and a wireless interface 230. Note that the SME is an upper entity of the MLME for transmitting, to the MLME as a lower entity, a request to make various settings of a wireless environment, and causing the MLME to make settings. Note that although the terms of the IEEE802.11 standard like “SME” and “MLME” are used in this example, they are used only for the descriptive purpose. That is, it is apparent that function units which have the equivalent functions and are defined by other terms can execute the above processes.

Referring to FIG. 4, the SME 4180 enables a plurality of BSSs (step S410). At this time, the same frequency channel may correspond to all the plurality of BSSs or different frequency channels may correspond to the plurality of BSSs. Note that the plurality of BSSs are enabled when the PCP/AP 10 informs the STA 20 of information of a plurality of BSSIDs. The PCP/AP 10 informs the STA 20 of the information by transmitting one or a plurality of beacons or transmitting a probe response, announcement frame, or the like defined in the IEEE802.11ad standard.

Subsequently, the SME 4180 initializes beam forming parameters as antenna settings held by the MLME 4190 (step S420). The SME 4180 of the PCP/AP 10 is connected to the SME 4280 of the STA 20 by performing authentication/association, security parameter setting, and the like using the first BSS (step S430).

After that, the SME 4180 of the PCP/AP 10 activates and executes the beam forming protocol (step S440). This beam forming protocol allows the MLME 4190 to specify at least the first beam forming parameter as an antenna setting for obtaining a communication path suitable for transmission/reception. Note that the beam forming protocol is one of an SLS (Sector Level Sweep) for performing coarse adjustment of the beam of the antenna and a BRP (Beam Refinement Protocol) for performing fine adjustment of the beam, or a combination thereof. A beam tracking protocol may be used in place of the beam forming protocol.

An example of the beam forming protocol executed in step S440 will be explained. The SME 4180 of the PCP/AP 10 issues an MLME-BF-TRAINING.request command to the MLME 4190 to request activation of the beam forming protocol (step S441). The MLME 4190 of the PCP/AP 10 executes the beam forming protocol with the MLME 4290 of the STA 20 (step S442), thereby generating a transaction of a packet defined in the IEEE802.11ad standard. In the beam forming protocol, coarse adjustment or fine adjustment of the beam can be performed for each of the transmission antenna and reception antenna by one of the SLS and BRP or a combination thereof. After that, the MLME 4290 of the STA 20 issues an MLME-BF-TRAINING.indication command to the SME 4280 to transmit the execution result of the beam forming protocol (step S443). Similarly, the MLME 4190 of the PCP/AP 10 issues an MLME-BF-TRAINING.confirm command to the SME 4180 to transmit the execution result of the beam forming protocol (step S444).

As a result of step S440, the MLME 4190 of the PCP/AP 10 can specify the first beam forming parameter with respect to the first communication path as a communication path suitable (for example, optimum) for communication with the STA 20. The MLME 4190 of the PCP/AP 10 associates the obtained first beam forming parameter with the first BSS. The beam forming parameter can be one of the execution result of the SLS and that of the BRP or an arbitrary combination thereof. The result of the beam tracking protocol may be used as a beam forming parameter.

After that, the SME 4180 of the PCP/AP 10 requests the MLME 4190 not to use the first beam forming parameter to search for the second communication path (step S450). The SME 4180 of the PCP/AP 10 is connected to the SME 4280 of the STA 20 by performing authentication/association, security parameter setting, and the like using the second BSS (step S460). When the same frequency band as that of the first BSS is used, a connection by the second BSS may be established by CSMA/CA, for example, by allocating time using the TDMA scheme. Note that when it is impossible to execute the processing in step S460, the PCP/AP 10 need not execute the processing in step S450 either.

After that, the SME 4180 of the PCP/AP 10 activates the beam forming protocol to establish the second communication path, similarly to step S440 (step S470). By executing the beam forming protocol, the MLME 4190 of the PCP/AP 10 can specify the second beam forming parameter for the second communication path. At this time, as described above, the second beam forming parameter is specified by setting, as candidates, parameters remaining by excluding the first beam forming parameter from possible parameters, searching the candidates for an appropriate parameter (directivity characteristics), and selecting it. The MLME 4190 of the PCP/AP 10 associates the second beam forming parameter with the second BSS.

The SME 4180 of the PCP/AP 10 performs data communication with the SME 4280 of the STA 20 using the first beam forming parameter in the first BSS (step S480). Similarly, the SME 4180 of the PCP/AP 10 performs data communication with the SME 4280 of the STA 20 using the second beam forming parameter in the second BSS (step S490).

Note that if the PCP/AP 10 cannot execute the processing in step S460, the above-described processes in steps S470 and S490 need not be executed.

(Processing Procedure by PCP/AP)

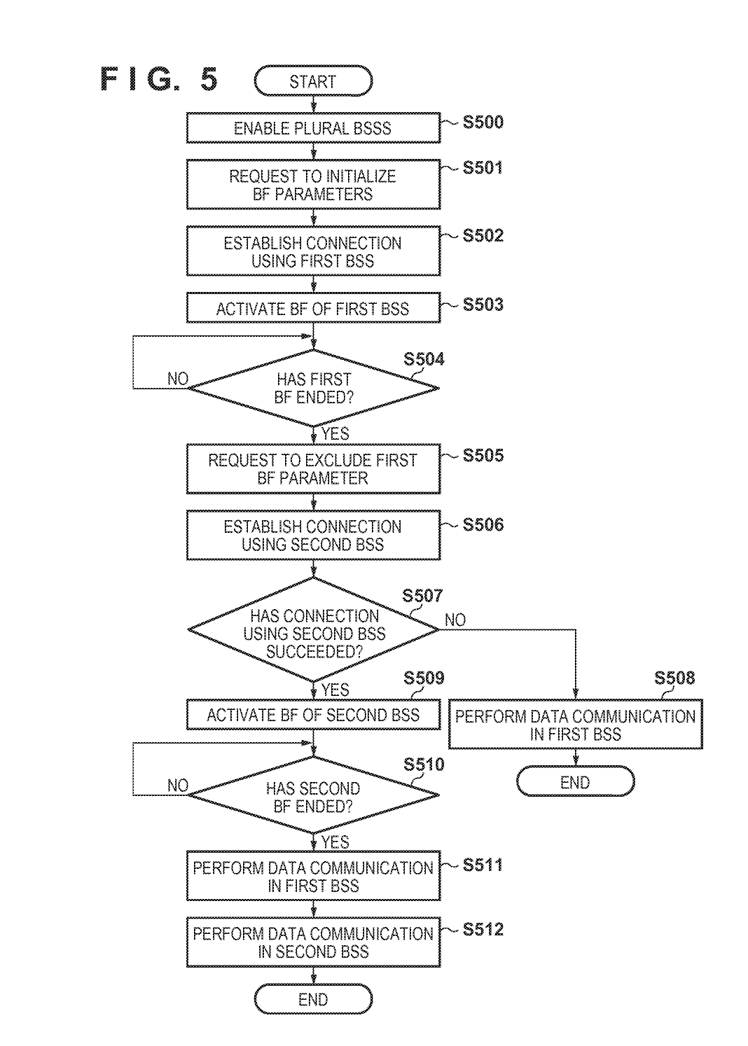

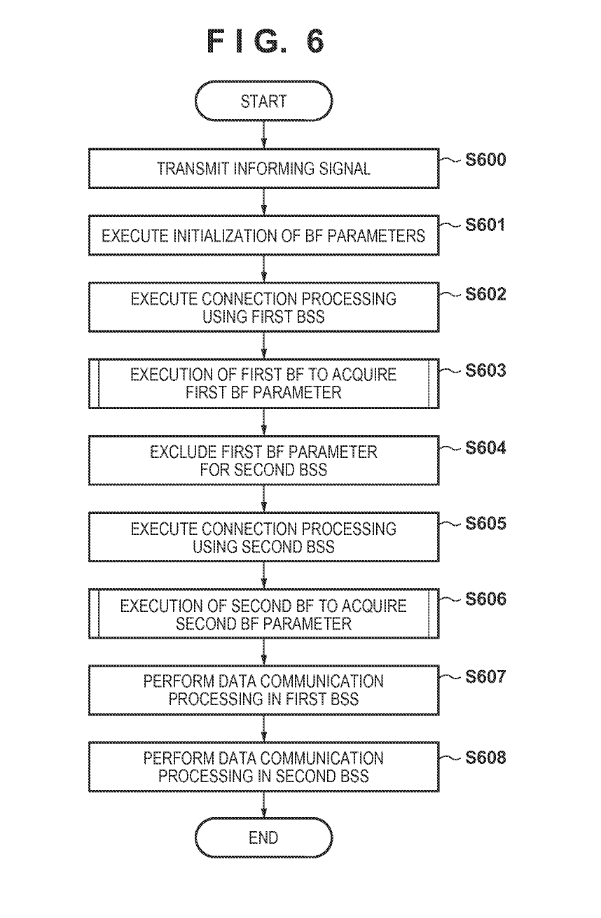

A processing procedure executed by the PCP/AP 10 according to this embodiment will be described with reference to FIGS. 5 and 6. FIG. 5 is a flowchart illustrating a processing procedure executed by the SME 4180 of the PCP/AP 10, and FIG. 6 is a flowchart illustrating a processing procedure executed by the MLME 4190 of the PCP/AP 10. Note that the processing shown in FIGS. 5 and 6 is performed when the central processing unit 220 reads out and executes programs stored in a nonvolatile memory 250 of the PCP/AP 10.

Upon start of the processing, the SME 4180 issues an informing signal transmission request as an instruction for informing the MLME 4190 of the existence of a plurality of BSSs (step S500). Upon accepting the informing signal transmission request from the SME 4180, the MLME 4190 transmits an informing signal such as a beacon. Note that the SME 4180 may be informed of the existence of the plurality of BSSs by one or a plurality of beacons, or by a probe response, announcement frame, or the like defined in the IEEE802.11ad standard.

The SME 4180 issues a request to initialize the beam forming parameters held in a volatile memory 240 by the MLME 4190 (step S501). Upon accepting the initialization request, the MLME 4190 initializes the beam forming parameters held in the volatile memory 240 (step S601).

After that, the SME 4180 is connected to the SME 4280 of the STA 20 by performing authentication/association, security parameter setting, and the like using the first BSS (step S502). At this time, the MLME 4190 executes connection processing to the MLME 4290 of the STA 20 using the first BSS (step S602). In this connection processing, authentication/association, security parameter setting, and the like are executed while selecting an appropriate transmission rate.

The SME 4180 requests the MLME 4190 to execute the first beam forming protocol (step S503). In response to the request from the SME 4180, the MLME 4190 executes the first beam forming protocol, and receives feedback information from the MLME 4290 of the STA 20 (step S603). At this time, a transaction of a packet defined in the IEEE802.11ad standard is generated. By receiving the feedback information, the MLME 4190 can specify setting information of the transmission antenna and reception antenna, each of the directions of directivity of which is set in a direction of a communication path having the highest communication quality or the communication quality of a predetermine level or higher. The setting information includes, for example, a phase shift amount and amplitude control amount corresponding to each of a plurality of antenna elements, and the MLME 4190 stores this setting information as the first beam forming parameter in the volatile memory 240. The MLME 4190 stores, in the volatile memory 240, information for associating the first beam forming parameter and BSSID1 as the first network ID with each other. The MLME 4190 notifies the SME 4180 of whether the first beam forming protocol has succeeded.

The SME 4180 stands by for the notification, from the MLME 4190, indicating whether the first beam forming protocol has succeeded (step S504). After receiving the notification (YES in step S504), the SME 4180 requests the MLME 4190 not to use the first beam forming parameter in the second BSS (step S505). Upon receiving the request from the SME 4180, the MLME 4190 sets not to use the first beam forming parameter at the time of execution of the second beam forming protocol with respect to the second network (step S604).

Subsequently, the SME 4180 is connected to the SME 4280 of the STA 20 by performing authentication/association, security parameter setting, and the like using the second BSS (step S506). At this time, the MLME 4190 executes connection processing to the MLME 4290 of the STA 20 using the second BSS (step S605). In this connection processing, authentication/association, security parameter setting, and the like are executed while selecting an appropriate transmission rate.

After that, the SME 4180 determines whether the connection using the second BSS has succeeded (step S507). If the connection has succeeded (YES in step S507), the process advances to step S509. On the other hand, if the connection using the second BSS has failed (NO in step S507), the SME 4180 performs data communication only in the first BSS as only one network for which the connection has succeeded (step S508). In this case, upon accepting designation of BSSID1 from the SME 4180, the MLME 4190 performs data communication using the associated first beam forming parameter by BSSID1 (step S607).

In step S509, the SME 4180 requests the MLME 4190 to activate the second beam forming protocol. In response to the request from the SME 4180, the MLME 4190 executes the second beam forming protocol, and receives feedback information from the MLME 4290 of the STA 20 (step S606). At this time, a transaction of a packet defined in the IEEE802.11ad standard is generated. Furthermore, the second beam forming parameter is specified by setting, as candidates, parameters remaining by excluding the first beam forming parameter from possible parameters, searching the candidates for an appropriate parameter (directivity characteristics), and selecting it. By receiving the feedback information, the MLME 4190 can obtain setting information of the transmission antenna and reception antenna, each of the directions of directivity of which is set in a direction of a communication path having the second highest preferable communication quality or the communication quality of a predetermined level or higher.

The setting information includes, for example, a phase shift amount and amplitude control amount corresponding to each of the plurality of antenna elements, and the MLME 4190 stores this setting information as the second beam forming parameter in the volatile memory 240. The MLME 4190 stores, in the volatile memory 240, information for associating the second beam forming parameter and BSSID2 as the second network ID with each other. Note that if the communication path obtained by the second beam forming protocol does not satisfy expected predetermined communication quality, for example, the MLME 4190 sets the second beam forming parameter to a value equal to the first beam forming parameter. The MLME 4190 notifies the SME 4180 of whether the beam forming protocol has succeeded.

On the other hand, the SME 4180 stands by for the notification indicating that the MLME 4190 has ended the second beam forming protocol (step S510). Upon accepting the end notification (YES in step S510), the SME 4180 performs data communication with the SME 4280 of the STA 20 using the first beam forming parameter in the first BSS (step S511). At this time, upon accepting designation of BSSID1 from the SME 4180, the MLME 4190 performs data communication using the associated first beam forming parameter by BSSID1 (step S607).

The SME 4180 performs data communication with the SME 4280 of the STA 20 using the second beam forming parameter in the second BSS (step S512). At this time, upon accepting designation of BSSID2 from the SME 4180, the MLME 4190 performs data communication using the associated second beam forming parameter by BSSID2 (step S607).

(Processing Procedure by STA)

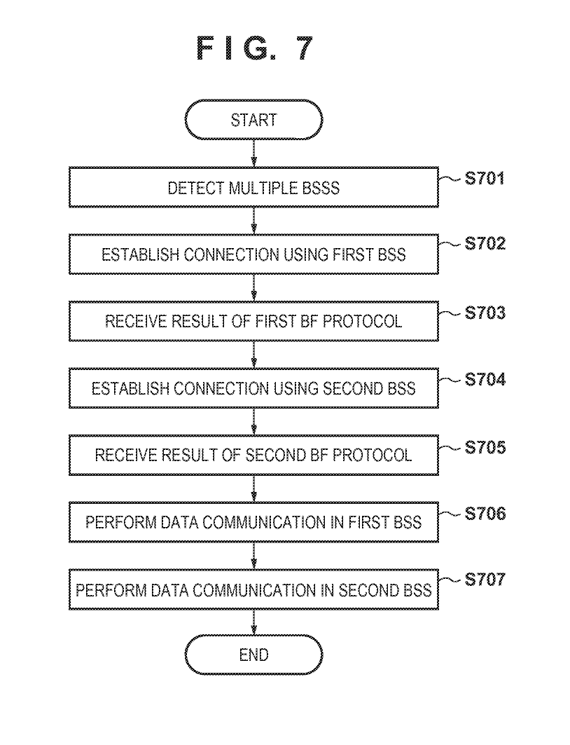

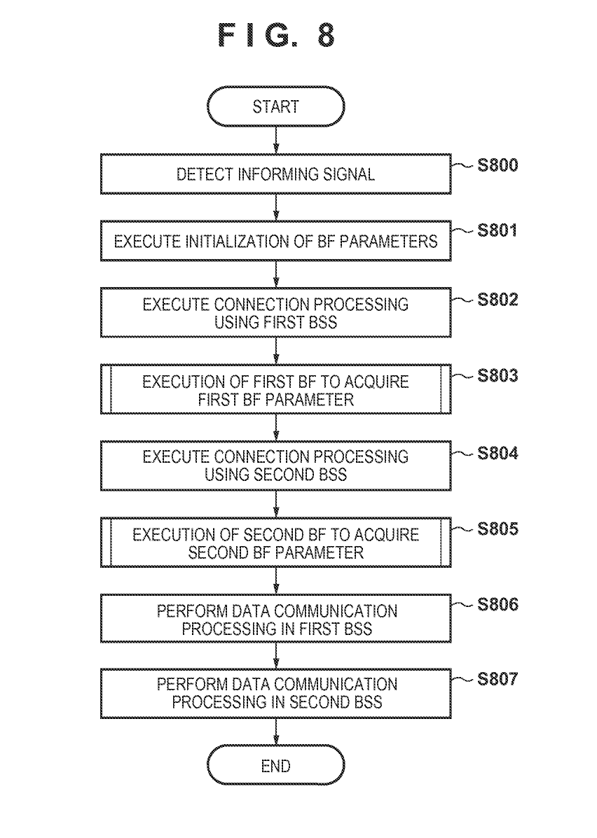

A processing procedure executed by the STA 20 according to this embodiment will be described with reference to FIGS. 7 and 8. FIG. 7 is a flowchart illustrating a processing procedure executed by the SME 4280 of the STA 20. FIG. 8 is a flowchart illustrating a processing procedure executed by the MLME 4290 of the STA 20. Note that the processing shown in FIGS. 7 and 8 is performed when the central processing unit 220 reads out and executes the programs stored in the nonvolatile memory 250 of the STA 20.

Upon start of the processing, the MLME 4290 detects the informing signal from the MLME 4190 of the PCP/AP 10, and notifies the SME 4280 of information of the plurality of BSSs (step S800). In response to this notification, the SME 4280 detects multiple BSSs (step S701). Note that the SME 4280 may be informed of the existence of the plurality of BSSs by one or a plurality of beacons, or by a probe response, announcement frame, or the like defined in the IEEE802.11ad standard.

After that, the SME 4280 performs connection processing to the SME 4180 of the PCP/AP 10 using the first BSS (step S702). At this time, the SME 4280 requests the MLME 4290 to initialize the beam forming parameters held in the volatile memory 240. Upon accepting the beam forming parameter initialization request from the SME 4280, the MLME 4290 initializes the beam forming parameters held in the volatile memory 240 (step S801). The MLME 4290 executes connection processing to the MLME 4190 of the PCP/AP 10 using the first BSS (step S802). In this connection processing, authentication/association, security parameter setting, and the like are executed while selecting an appropriate transmission rate.

After that, in response to the request from the SME 4180 of the PCP/AP 10, the MLME 4290 executes the first beam forming protocol with the MLME 4190 of the PCP/AP 10 (step S803). The MLME 4290 receives feedback information from the MLME 4190 of the PCP/AP 10 in the first beam forming protocol. By receiving the feedback information, the MLME 4290 can obtain setting information of the transmission antenna and reception antenna, each of the directions of directivity of which is set in a direction of a communication path having the highest communication quality or the communication quality of a predetermined level or higher. The setting information includes, for example, a phase shift amount and amplitude control amount corresponding to each of a plurality of antenna elements, and the MLME 4290 stores this setting information as the first beam forming parameter in the volatile memory 240. The MLME 4290 stores, in the volatile memory 240, information for associating the first beam forming parameter and BSSID1 as the first network ID with each other. The MLME 4290 notifies the SME 4280 of the result of the first beam forming protocol.

The SME 4280 receives a notification indicating whether the execution result of the first beam forming protocol executed by the MLME 4290 indicates success (step S703). The SME 4280 executes connection processing to the SME 4180 of the PCP/AP 10 using the second BSS (step S704). At this time, the MLME 4290 executes connection processing to the MLME 4290 of the PCP/AP 10 using the second BSS (step S804). In this connection processing, authentication/association, security parameter setting, and the like are executed while selecting an appropriate transmission rate.

After that, in response to the request from the SME 4180 of the PCP/AP 10, the MLME 4290 executes the second beam forming protocol with the MLME 4190 of the PCP/AP 10 (step S805). The MLME 4290 receives feedback information from the MLME 4190 of the PCP/AP 10 in the second beam forming protocol. At this time, as described above, the second beam forming parameter is specified by setting, as candidates, parameters remaining by excluding the first beam forming parameter from possible parameters, searching the candidates for an appropriate parameter, and selecting it. By receiving the feedback information, the MLME 4290 can obtain setting information of the transmission antenna and reception antenna, each of the directions of directivity of which is set in a direction of a communication path having the second highest communication quality or the communication quality of a predetermined level or higher. The setting information includes, for example, a phase shift amount and amplitude control amount corresponding to each of the plurality of antenna elements, and the MLME 4290 stores this setting information as the second beam forming parameter in the volatile memory 240. The MLME 4290 stores, in the volatile memory 240, information for associating the second beam forming parameter and BSSID2 as the second network ID with each other. Note that if the communication path obtained by the second beam forming protocol does not satisfy expected predetermined communication quality, for example, the MLME 4290 sets the second beam forming parameter to a value equal to the first beam forming parameter. The MLME 4290 notifies the SME 4280 of the result of the second beam forming protocol. The SME 4280 receives the notification indicating whether the execution result of the second beam forming protocol executed by the MLME 4290 indicates success (step S705).

After that, the SME 4280 performs data communication with the SME 4180 of the PCP/AP 10 in the first BSS (step S706). At this time, upon accepting designation of BSSID1 from the SME 4280, the MLME 4290 performs data communication using the associated first beam forming parameter by BSSID1 (step S806). The SME 4280 performs data communication with the SME 4180 of the PCP/AP 10 in the second BSS (step S707). At this time, upon accepting designation of BSSID2 from the SME 4280, the MLME 4290 performs data communication using the associated second beam forming parameter by BSSID2 (step S807).

Execution of the beam forming protocol is activated by the PCP/AP 10 in this embodiment but may be activated by the STA 20. In this case, for example, the STA 20 executes the processes in steps S501 and S601 of FIGS. 5 and 6 and subsequent steps after executing steps S701 and S800 of FIGS. 7 and 8. On the other hand, the PCP/AP 10 executes the processes in steps S702 and S801 of FIGS. 7 and 8 and subsequent steps after executing steps S500 and S600 of FIGS. 5 and 6.

Referring to FIG. 4, in step S420, the SME 4280 of the STA 20 initializes the beam forming parameters held in the MLME 4290. In step S440, the SME 4280 of the STA 20 issues an MLME-BF-TRAINING.request command to the MLME 4290 to request activation of the beam forming protocol. The MLME 4290 of the STA 20 executes the beam forming protocol with the MLME 4190 of the PCP/AP 10. After that, the MLME 4190 of the PCP/AP 10 issues an MLME-BF-TRAINING.indication command to the SME 4180 to transmit the execution result of the beam forming protocol. Similarly, the MLME 4290 of the STA 20 issues an MLME-BF-TRAINING.confirm command to the SME 4280 to transmit the execution result of the beam forming protocol. The same applies to step S470. Note that after step S440, in step S450, the SME 4280 of the STA 20 requests the MLME 4290 not to use the first beam forming parameter to search for the second communication path. As described above, either the PCP/AP 10 or the STA 20 may activate the beam forming protocol.

Although a case in which two beam forming parameters are searched for between the PCP/AP 10 and the STA 20 has been explained in this embodiment, N (N>2) beam forming parameters may be searched for. In this case, the PCP/AP 10 forms N BSSs. When searching for the nth (2≦n≦N) beam forming parameter after searching for the first beam forming parameter, the PCP/AP 10 excludes the beam forming parameters found up to the (n−1)th beam forming parameter. If the PCP/AP 10 activates the beam forming protocol, the SME 4180 repeats steps S450 to S470, and requests, in step S450, to exclude all the precedingly found beam forming parameters. If the STA 20 activates the beam forming protocol, the SME 4280 repeats steps S450 to S470, and requests, in step S450, to exclude all the precedingly found beam forming parameters.

### Second Embodiment

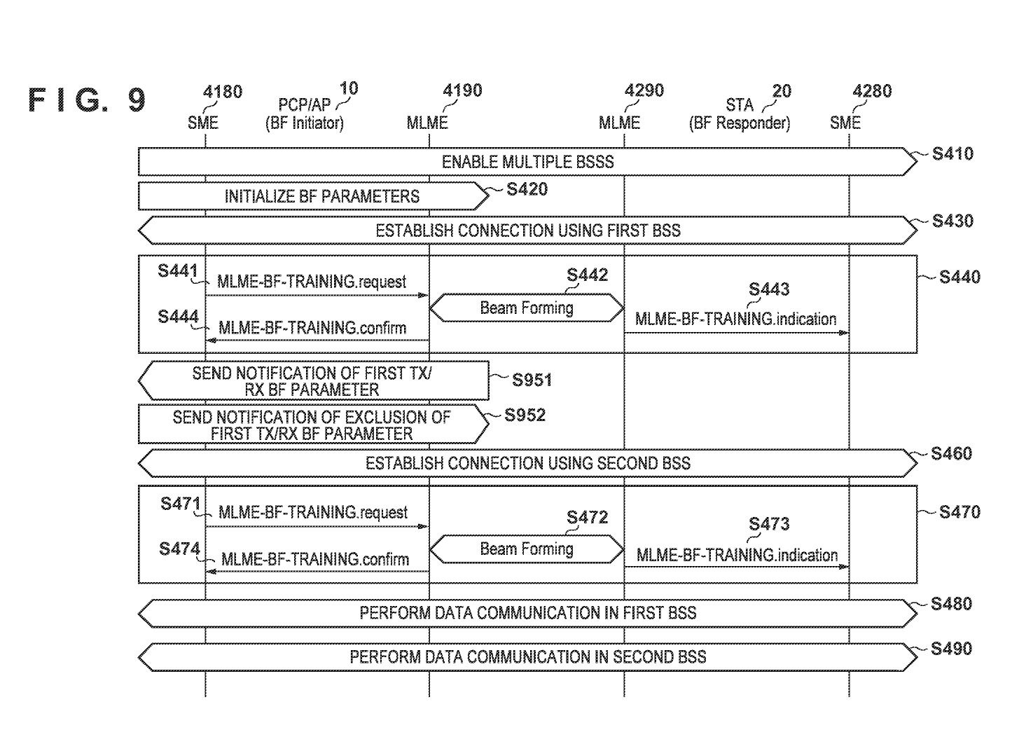

In this embodiment, in a PCP/AP 10, an MLME 4190 notifies an SME 4180 of the first beam forming parameter. When specifying the second beam forming parameter associated with the second network, the MLME 4190 excludes the first beam forming parameter designated by the SME 4180 from search candidates. A difference in a processing procedure from the first embodiment will be described in detail below with reference to FIGS. 9 to 11.

FIG. 9 is a sequence chart showing a processing procedure executed in a wireless communication system according to this embodiment. Note that in this embodiment, in the sequence chart shown in FIG. 4, step S951 is added and step S450 is replaced by step S952. In step S951, the MLME 4190 of the PCP/AP 10 notifies the SME 4180 of the obtained first beam forming parameter to transmit the result of the beam forming protocol in step S442. In step S952, the SME 4180 of the PCP/AP 10 designates the beam forming parameter for the MLME 4190, and instructs not to use the value at the time of execution of the second beam forming protocol. The beam forming parameter value may be transmitted in steps S951 and S952 by transmitting the value in the PCP/AP 10 or transmitting a reference pointer storing the value.

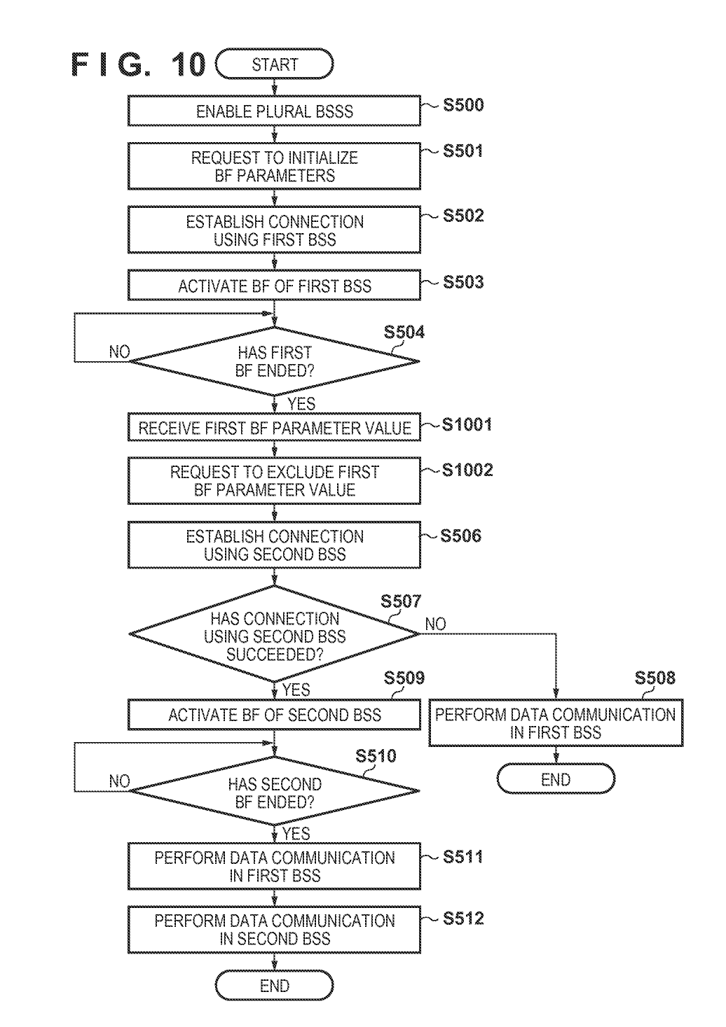

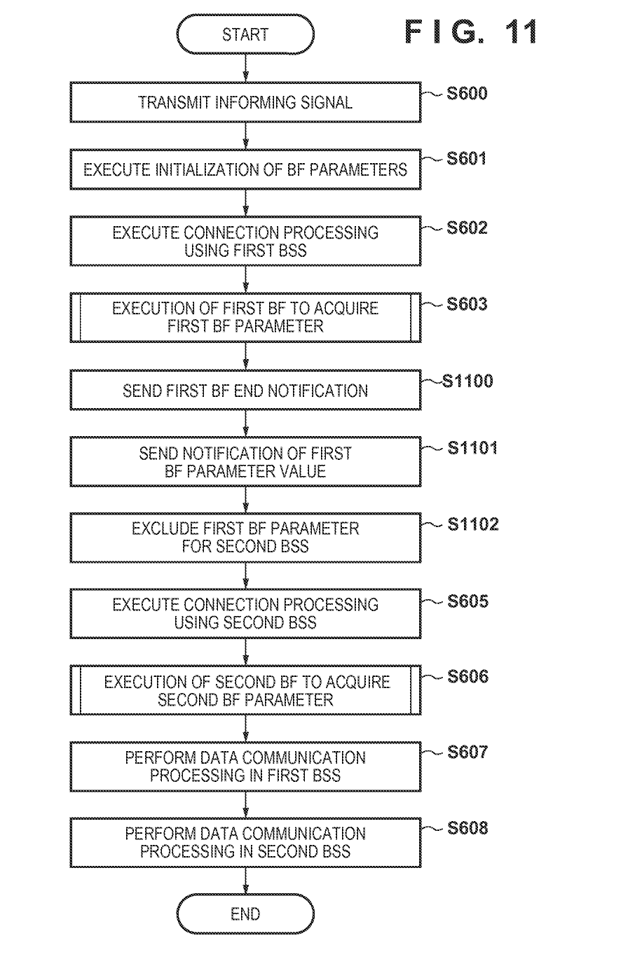

FIGS. 10 and 11 show processing procedures executed by the SME 4180 and MLME 4190 of the PCP/AP 10 according to this embodiment. The difference between FIGS. 10 and 5 is that processes in steps S1001 and S1002 are included in FIG. 10 instead of step S505. In step S1001, the SME 4180 receives the first beam forming parameter obtained by the MLME 4190. In step S1002, the SME 4180 designates the first beam forming parameter to the MLME 4190, and instructs not to use the value at the time of execution of the second beam forming protocol.

On the other hand, the difference between FIGS. 11 and 6 is that processes in steps S1100 to S1102 are included in FIG. 11 instead of step S604. In step 1100, the MLME 4190 of the PCP/AP 10 sends first BF end notification. In step S1101, the MLME 4190 of the PCP/AP 10 transfers the first beam forming parameter to the SME 4180. In step S1102, the MLME 4190 of the PCP/AP 10 accepts an instruction not to use, in the second beam forming protocol, the first beam forming parameter designated by the SME 4180. The MLME 4190 of the PCP/AP 10 excludes the first beam forming parameter from search candidates at the time of execution of the second beam forming protocol in subsequent processing.

Note that execution of the beam forming protocol is activated by the PCP/AP 10 in this embodiment as well but may be activated by an STA 20. In this case, the STA 20 executes processes in steps S501 and S601 of FIGS. 10 and 11 and subsequent steps after executing steps S701 and S800 of FIGS. 7 and 8. On the other hand, the PCP/AP 10 executes processes in steps S702 and S801 of FIGS. 7 and 8 and subsequent steps after executing steps S500 and S600 of FIGS. 10 and 11.

Referring to FIG. 9, in step S420, an SME 4280 of the STA 20 initializes beam forming parameters held by an MLME 4290. In step S440, the SME 4280 of the STA 20 issues an MLME-BF-TRAINING.request command to the MLME 4290 to request activation of the beam forming protocol. The MLME 4290 of the STA 20 executes the beam forming protocol with the MLME 4190 of the PCP/AP 10. After that, the MLME 4190 of the PCP/AP 10 issues an MLME-BF-TRAINING.indication command to the SME 4180 to transmit the execution result of the beam forming protocol. Similarly, the MLME 4290 of the STA 20 issues an MLME-BF-TRAINING.confirm command to the SME 4280 to transmit the execution result of the beam forming protocol. The same applies to step S470. Note that after step S440, in step S951, the MLME 4290 of the STA 20 notifies the SME 4280 of the obtained first beam forming parameter to transmit the result of the beam forming protocol in step S442. In step S952, the SME 4280 of the STA 20 designates the beam forming parameter to the MLME 4290, and instructs not to use the value at the time of execution of the second beam forming protocol. As described above, in this embodiment as well, either the PCP/AP 10 or the STA 20 may activate the beam forming protocol.

Each of the above-described embodiments assumes that the plurality of antenna directivity characteristics are directional in the wireless interface 230 to execute the beam forming protocol. The present invention, however, is not limited to this. That is, for example, even if one of the antenna directivity characteristics to be used is a nondirectional antenna, that is, a pseudo omni-directional antenna, all of the above description can be applied. Although a case in which the PCP/AP 10 and STA 20 execute the beam forming protocol every time connection is performed by each of a plurality of BSSs has been explained in each of the above-described embodiments, the present invention is not limited to this. For example, the PCP/AP 10 and the STA 20 may establish in advance connections by a plurality of BSSs, and then execute the beam forming protocol a plurality of times with respect to the respective BSSs.

According to each of the above-described embodiments, when specifying a direction of directivity (parameter) for a given network, a direction of directivity (parameter) already specified with respect to another network is excluded from selection candidates, and then the direction of directivity is specified from the selection candidates. This makes it possible to specify different directions of directivity corresponding to a plurality of different communication paths with respect to a plurality of different networks.

Note that when the second parameter corresponding to the second communication path for the first network is specified after the first parameter corresponding to the first communication path for the first network is specified, a connection by the first parameter may be disconnected. It is possible to prevent such disconnection by specifying the second parameter for the second network. Therefore, since different communication paths are managed in the first network associated with the first BSS and the second network associated with the second BSS, the PCP/AP 10 and STA 20 can redundantly transmit the same data via the different networks. As a result, it is possible to perform more reliable communication by selecting higher-quality one of data received via the different communication paths or combining the received data in the receiver.

Although a case in which two beam forming parameters are searched for between the PCP/AP 10 and the STA 20 has been explained in this embodiment, N (N>2) beam forming parameters may be searched for. In this case, the PCP/AP 10 forms N BSSs. When searching for the nth (2≦n≦N) beam forming parameter after searching for the first beam forming parameter, the PCP/AP 10 excludes the beam forming parameters found up to the (n−1)th beam forming parameter. If the PCP/AP 10 activates the beam forming protocol, the SME 4180 repeats steps S951, S952, S460, and S470, and requests, in step S952, to eliminate all the precedingly found beam forming parameters. If the STA 20 activates the beam forming protocol, the SME 4280 repeats steps S951, S952, S460, and S470, and requests, in step S952, to eliminate all the precedingly found beam forming parameters.

Although the embodiments of the present invention have been described in detail, the present invention can adopt an embodiment in the form of, for example, a system, apparatus, method, program, or storage medium. More specifically, the present invention may be applied to a system constituted by a plurality of devices, or an apparatus comprising a single device.

According to the present invention, it is possible to readily specify and control the antenna directivity characteristics to simultaneously establish a plurality of high-speed communication paths.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-195806, filed Sep. 25, 2014, which is hereby incorporated by reference herein in its entirety.

What is claimed is:

1. A communication apparatus comprising:
an antenna, for which directivity characteristics can be changed by setting parameters;
a specifying unit configured to specify the parameters of said antenna to obtain directivity characteristics to be used for communication, wherein the specifying unit searches for and specifies, after specifying a first parameter having a direction of directivity corresponding to a first communication path with another communication apparatus, a second parameter having a direction of directivity corresponding to a second communication path with the other communication apparatus from parameters obtained by excluding the first parameter from possible parameters; and
a communication unit configured to communicate with the other communication apparatus by setting said antenna using the first parameter and the second parameter.

2. The apparatus according to claim 1, wherein
said specifying unit specifies the first parameter from the possible parameters.

3. The apparatus according to claim 1, wherein
said specifying unit specifies the parameters of said antenna to obtain directivity characteristics which provide one of highest communication quality and communication quality not less than a predetermined level.

4. The apparatus according to claim 1, wherein
said specifying unit specifies the parameters of said antenna by performing at least one of coarse adjustment and fine adjustment of the directivity characteristics with the other communication apparatus.

5. The apparatus according to claim 1, wherein
said specifying unit specifies the parameters of said antenna for each of a plurality of networks for connecting to the other communication apparatus.

6. The apparatus according to claim 5, further comprising:
an establishment unit configured to establish a network for connecting to the other communication apparatus,
wherein after said establishment unit establishes the network, said specifying unit specifies the parameters of said antenna with respect to the network.

7. The apparatus according to claim 6, wherein
after said specifying unit specifies the first parameter associated with a first network, said establishment unit establishes a second network.

8. The apparatus according to claim 7, wherein
if said establishment unit cannot establish the second network, said specifying unit does not specify the parameters of said antenna with respect to the second network.

9. The apparatus according to claim 1, wherein
in response to the other communication apparatus activating a protocol for specifying the parameters of said antenna, said specifying unit specifies the parameters of said antenna in accordance with the protocol.

10. The apparatus according to claim 1, wherein
said specifying unit activates a protocol for specifying the parameters of said antenna, and specifies the parameters of said antenna in accordance with the protocol.

11. The apparatus according to claim 1, wherein
said specifying unit specifies the parameters of said antenna by a protocol defined in an IEEE802.11ad standard.

12. A control method for a communication apparatus including an antenna, for which directivity characteristics can be changed by setting parameters, and a communication unit configured to communicate with another communication apparatus by setting the antenna using specified parameters, the method comprising:
specifying the parameters of the antenna to obtain directivity characteristics to be used for communication, wherein after a first parameter having a direction of directivity corresponding to a first communication path with the other communication apparatus is specified, a second parameter having a direction of directivity corresponding to a second communication path with the other communication apparatus from parameters obtained by excluding the first parameter from possible parameters is searched for and specified; and
controlling the communication unit to communicate with the other communication apparatus by setting the antenna using the first parameter and the second parameter.

13. A non-transitory computer-readable storage medium storing a computer program for causing, to execute a control method, a computer of a communication apparatus including an antenna, for which directivity characteristics can be changed by setting parameters and a communication unit configured to communicate with another communication apparatus by setting the antenna using specified parameters, the program comprising:
specifying the parameters of the antenna to obtain directivity characteristics to be used for communication, wherein after a first parameter having a direction of directivity corresponding to a first communication path with the other communication apparatus is specified, a second parameter having a direction of directivity corresponding to a second communication path with the other communication apparatus from parameters obtained by excluding the first parameter from possible parameters is searched for and specified; and
controlling the communication unit to communicate with the other communication apparatus by setting the antenna using the first parameter and the second parameter.
